(19) United States
(12) Patent Application Publication
(10) Pub. No.: US 2007/0141545 A1
(43) Pub. Date: Jun. 21, 2007

(54) Content-Based Indexing and Retrieval Methods for Surround Video Synthesis

(76) Inventors: Kar-Han Tan, Palo Alto, CA (US); Anoop K. Bhattacharjya, Campbell, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/461,407

(22) Filed: Jul. 31, 2006

Related U.S. Application Data
(63) Continuation-in-part of application No. 11/294,023, filed on Dec. 5, 2005.

(51) Int. Cl. G09B 25/00

(52) U.S. Cl. 434/365

(57) ABSTRACT

Systems and methods for synthesizing a surround visual field of image related to an input image are described. In one embodiment, the surround visual field is displayed in an area partially surrounding or surrounding an input image being displayed. In an embodiment, this surround visual field may comprise a plurality of images selected from a database of still images and/or video images based upon a characteristic or characteristics that relate to the displayed input image.

### CROSS-REFERENCE TO RELATED APPLICATIONS

This application is a continuation-in-part of, and claims priority to, co-pending and commonly-assigned U.S. patent application Ser. No. 11/294,023, filed on Dec. 5, 2005, entitled “IMMERSIVE SURROUND VISUAL FIELDS,” listing inventors Kar-Han Tan and Anoop K. Bhattacharjya, which is incorporated herein by reference in its entirety.

### BACKGROUND

A. Technical Field

The present invention relates generally to the visual enhancement of an audio/video presentation, and more particularly, to systems and methods that can synthesize and display a surround visual field comprising one and/or more still images or audio/visual images.

B. Background of the Invention

Various technological advancements in the audio/visual entertainment industry have enhanced the experience of an individual viewing media content. A number of these technological advancements improved the quality of video images being displayed on devices such as televisions, movie theatre systems, computers, portable video devices, and other such devices. Other advancements improved the quality of audio provided to an individual during the display of media content. These advancements in audio/visual presentation technology were intended to improve the enjoyment of an individual or individuals viewing this media content.

These attempts to improve the audio/visual presentation have focused on the display of a single audio/video presentation. Current display technologies have not addressed methods of displaying multiple images of related content to create an immersive experience that efficiently and effectively displays the related content. With the proliferation of multimedia content, an individual may wish to simultaneously view a number of related content items; however, no such systems exist to allow the effective display of such content. Although some devices may have the ability to show a picture within a picture, such devices do not have the ability to display multiple input streams of related content. Accordingly, what is needed are systems and methods that address the above-described limitations.

### SUMMARY OF THE INVENTION

An embodiment of the present invention provides a surround visual field, which relates to audio/visual input image content. In one embodiment of the invention, the surround visual field is synthesized and displayed in an area that partially or completely surrounds the display of the input image. This surround visual field is intended to further enhance the viewing experience of the displayed content. Accordingly, the surround visual field may enhance, extend, or otherwise supplement a characteristic or characteristics of the content being displayed. One skilled in the art will recognize that the surround visual field may relate to one or more characteristics of the input image. A characteristic of the input image shall be construed to include one or more characteristics related to the content being displayed including, but not limited to, input image content, metadata, visual features, motion, color, intensity, audio, genre, and action, and to user-provided input.

In one embodiment of the invention, the surround visual field is projected or displayed during the presentation of audio/video content. The size, location, and shape of this surround visual field may be defined by an author of the visual field, may relate to the content being displayed, or be otherwise defined. In embodiments, the surround visual field may be displayed in one or more portions of otherwise idle display areas. One skilled in the art will recognize that various audio/visual or display systems may be used to generate and control the surround visual field; all of these systems are intended to fall within the scope of the present invention.

In one exemplary embodiment of the invention, a surround visual field is synthesized by analyzing an input image to obtain a characteristic or characteristic of the input image. In an embodiment, the processing of analyzing the input image to obtain a characteristic of the input image may involve using one or more content-based analysis techniques to obtain a content-based characteristic as the characteristic. Using the characteristic(s) of the input image, a database of images (still images or video images) may be selectively searched to obtain one or more images that are related to the characteristic(s). These images may then be synthesized into a surround visual field for displaying in an area that at least partially surrounds the display of the input image. In an embodiment, the database of images may be a content-based indexing and retrieval database.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an illustration of a surround visual field system including a display device according to one embodiment of the invention.

FIG. 2 is an illustration of a television set with surround visual field according to one embodiment of the invention.

FIG. 3 is an illustration of a television set with surround visual field from a projector according to one embodiment of the invention.

FIG. 4 is an illustration of a television set with surround visual field from a projector and reflective device according to one embodiment of the invention.

FIG. 5 is a block diagram of an exemplary surround visual field controller in which a projected surround visual field relates to the image displayed in the center area according to one embodiment of the invention.

FIG. 6 is an exemplary surround visual field comprising a plurality of images that is displayed in conjunction with the display of an input image according to one embodiment of the invention.

FIG. 7 is an exemplary method for generating a surround visual field using context-based indexing and retrieval methods according to one embodiment of the invention.

FIG. 8 is an exemplary surround visual field comprising a plurality of images that is displayed in conjunction with the display of an input image according to one embodiment of the invention.

FIG. 9 is an exemplary surround visual field comprising a plurality of images that is displayed in conjunction with the display of an input image according to one embodiment of the invention.

### DETAILED DESCRIPTION OF THE PREFERRED EMBODIMENTS

Systems, devices, and methods are described for providing a surround visual field that may be used in conjunction with a database(s) of images, including video images and/or still images, to simultaneously present related content. In an embodiment, a surround visual field of images is synthesized and displayed in conjunction with the presentation of the input image. In an embodiment, the images within the surround visual field may have a characteristic or characteristics that relate to the input image and supplement the viewing experience. One skilled in the art will recognize that the surround visual field and the input image may be related in numerous ways and visually presented to an individual; all of which fall under the scope of the present invention.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including projection systems, theatre systems, televisions, home entertainment systems, computers, portable devices, and other types of multimedia systems. The embodiments of the present invention may also be present in software, hardware, firmware, or combinations thereof. Structures and devices shown below in block diagram are illustrative of exemplary embodiments of the invention and are meant to avoid obscuring the invention. Furthermore, connections between components and/or modules within the figures are not intended to be limited to direct connections. Data between these components and modules may be modified, re-formatted, or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” or “in an embodiment” in various places in the specification are not necessarily all referring to the same embodiment.

A. Surround Visual Field Display System

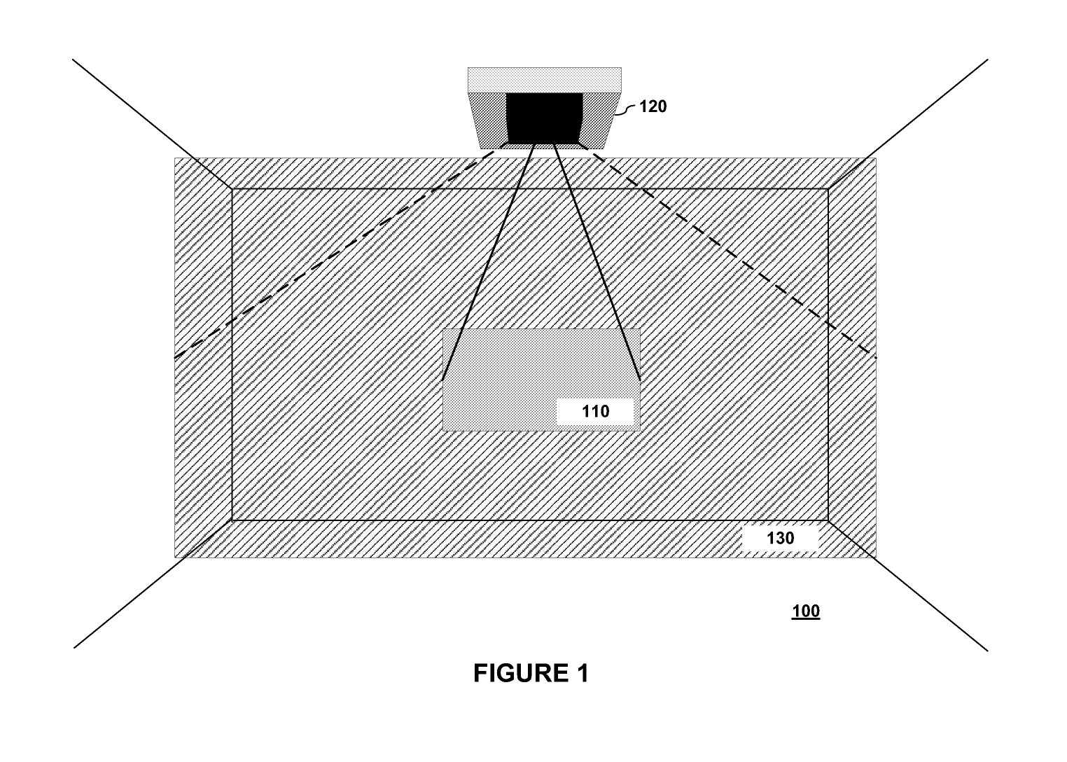

FIG. 1 illustrates a surround visual field display system according to an embodiment of the invention. In the embodiment depicted in FIG. 1, the system 100 includes display device 120 that displays images, which shall be understood to include video images and/or still images, within a first or central area 110 and a surround visual field in a second area 130 surrounding the first area 110. The surround visual field does not necessarily need to be projected around the first area 110; rather, this second area 130 may partially surround the first area 110, be adjacent to the first area 110, or otherwise projected into an individual's field of view.

The projector may be a single conventional projector, a single panoramic projector, multiple mosaiced projectors, a mirrored projector, projectors with panoramic projection fields, any hybrid of these types of projectors, or any other type of projector from which a surround visual field may be displayed. By employing wide angle optics, one or more projectors can be made to project a large field of view. Methods for achieving this include, but are not limited to, the use of fisheye lenses and catadioptric systems involving the use of curved mirrors, cone mirrors, or mirror pyramids. The surround visual field projected into the second area 130 may include various images, patterns, shapes, colors, and textures, which may include discrete elements of varying size and attributes, and which may relate to one or more characteristics of the image that is being displayed in the first area 110.

In an embodiment of the invention, a surround visual field is projected in the second area 130 but not within the first area 110 where the input image is being displayed. In another embodiment of the invention, the surround visual field may also be projected into the first area 110 or both the first area 110 and the second area 130. In an embodiment, if the surround visual field is projected into the first area 110, certain aspects of the displayed video content may be highlighted, emphasized, or otherwise supplemented by the surround visual field.

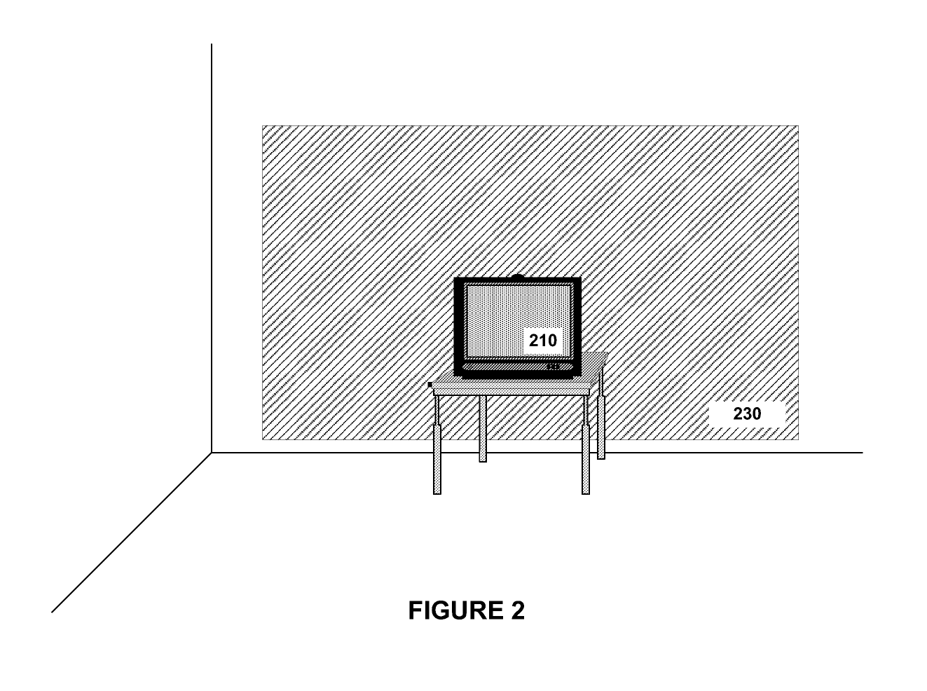

FIG. 2 illustrates a surround visual field in relation to a television set according to one embodiment of the invention. A television set having a defined viewing screen 210 is supplemented with a surround visual field displayed 230 behind the television set. For example, a large television set or a video wall, comprising a wall for displaying a projected image or a display or set of displays, may be used to display the surround field 230. This surface 230 may vary in size and shape and is not limited to just a single wall but may be expanded to cover as much area within the room as desired. Furthermore, the surface 230 does not necessarily need to surround the television set, as illustrated, but may partially surround the television set or be located in various other positions on the wall or walls. As described above, the images within the surround visual field may have various characteristics that relate to the image or images displayed on the television screen 210. Various embodiments of the invention may be employed to project the surround visual field onto the surface of the wall or television set. Two examples are described below; although one skilled in the art will recognize other embodiments are within the scope of the present invention.

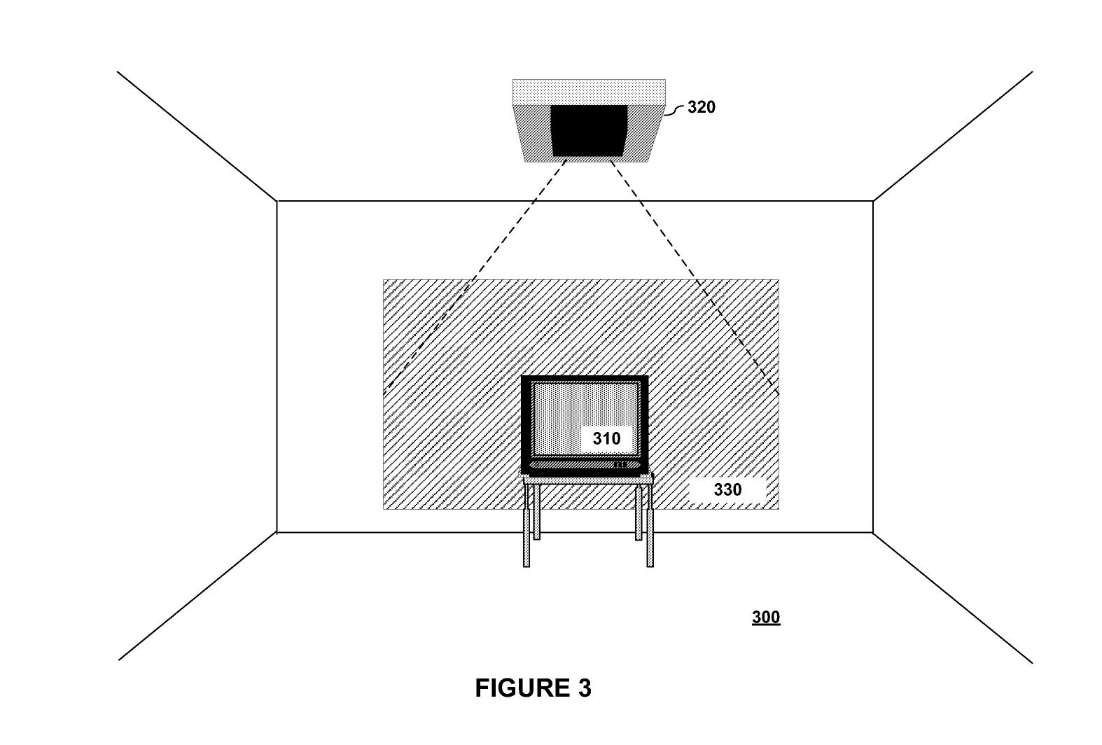

FIG. 3 illustrates one embodiment of the invention in which a surround visual field is projected directly onto an area 330 to supplement content displayed on a television screen 310 or other surface. Although illustrated as being shown on only one wall, the area 330 may extend to multiple walls ceiling, or floor depending on the type of projector 320 used and/or the room configuration. The projector 320 is integrated with or connected to a device (not shown) that controls the surround visual field. In one embodiment, this device may be provided with the input image, which may be an audio/video input image stream, which is displayed on the television screen 310. In another embodiment, this device may contain data that synchronize the surround visual field to the content being displayed on the television screen 310. In various embodiments of the invention, the input image is analyzed relative to one or more characteristic so that the surround visual field may be rendered to relate to the content displayed on the television screen 310.

In an embodiment, sensors may be positioned on components within the surround visual field system and may be used to ensure that proper alignment and calibration between components are maintained, may allow the system to adapt to its particular environment, and/or may be used to provide input. For example, in the system illustrated in FIG. 3, the projector 320 may identify the portion of its projection field in which the television is located. This identification allows the projector 320: (1) to center the surround visual field (within the area 330) around the screen 310 of the television set; (2) to prevent the projection, if so desired, of the surround visual field onto the television; and/or (3) to assist in making sure that the surround visual field pattern mosaics with the display 310.

In one embodiment, the sensors may be mounted separately from the projection or display optics. In another embodiment, the sensors may be designed to share at least one optical path for the projector or display, for example by using a beam splitter.

In an embodiment of the invention, a video display and surround visual field may be shown within the boundaries of a display device such as a television set, computer monitor, laptop computer, portable device, gaming device, and the like. In this particular embodiment, a projection device for the surround visual field may not be required. Traditional display devices do not always utilize all of their display capabilities. For example, when displaying input images in a letterbox format, differences in aspect ratio between the display and the input images may result in unused portions of the display area. Accordingly, an aspect of the present invention involves utilizing some or all of this unused, or idle, display area to display a surround visual field.

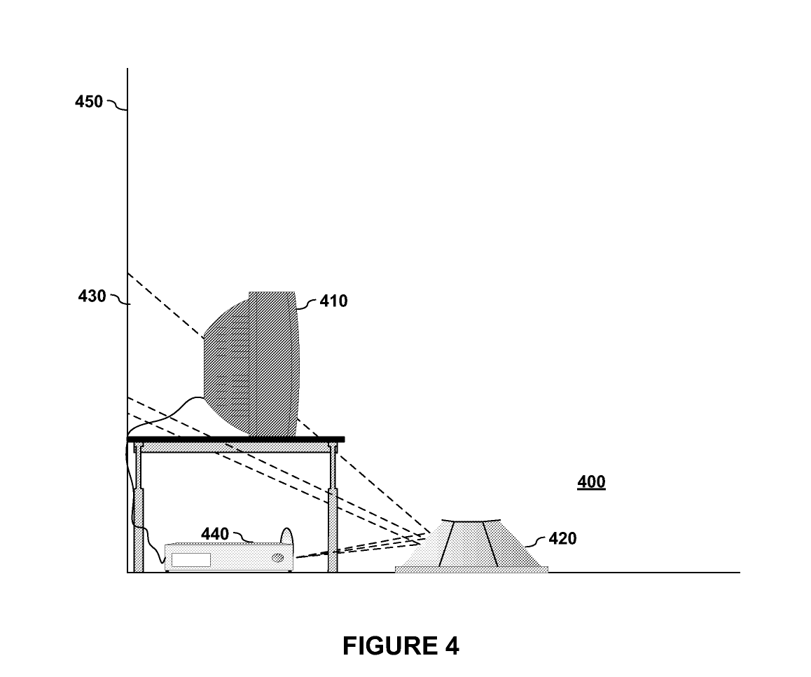

FIG. 4 illustrates a reflective system for providing surround visual fields according to another embodiment of the invention. The system 400 may include a single projector or multiple projectors 440 that are used to generate the surround visual field. In one embodiment of the invention, a plurality of light projectors 440 produces a visual field that is reflected off a mirrored pyramid 420 in order to effectively create a virtual projector. The plurality of light projectors 440 may be integrated within the same projector housing or in separate housings. The mirrored pyramid 420 may have multiple reflective surfaces that allow light to be reflected from the projector to a preferred area in which the surround visual field is to be displayed. The design of the mirrored pyramid 420 may vary depending on the desired area in which the visual field is to be displayed and the type and number of projectors used within the system. Additionally, other types of reflective devices may also be used within the system to reflect a visual field from a projector onto a desired surface. In another embodiment, a single projector may be used that uses one reflective surface of the mirror pyramid 420, effectively using a planar mirror. The single projector may also project onto multiple faces of the mirror pyramid 420, in which a plurality of virtual optical centers is created.

In one embodiment of the invention, the projector or projectors 440 project a surround visual field 430 that is reflected and projected onto a surface of the wall 450 behind the television 410. As described above, this surround visual field may comprise various images that relate in some manner to the image or images being displayed on the television 410.

One skilled in the art will recognize that various reflective devices and configurations may be used within the system 400 to achieve varying results in the surround visual field. Furthermore, the projector 440 or projectors may be integrated within the television 410 or furniture holding the television 410.

One skilled in the art will also recognize that one or more displays may be utilized to display the input images and a surround visual field, including but not limited to, a single display or a set of displays, such as a set of tiled displays.

B. Surround Visual Display System and Content-Based Indexing and Retrieval

In an embodiment of the present invention, a surround visual field may be integrated with or used in conjunction with content-based indexing and retrieval (CBIR) techniques or systems to generate a surround visual field. As described in more detail below, the contents of the input stream may be analyzed and used to index or query one or more databases of images (still images, video images, or both). The images retrieved from the database may then be used to synthesize the surround visual field.

Content-based indexing and retrieval is a widely-studied field. Data indexing and retrieval systems deal with efficient storage and retrieval of records. Traditional database techniques function well for applications involving alphanumeric records, which can be readily indexed and searched for matching patterns. Some of these methods may be utilized for images, more particularly, to alphanumeric phrases associated with the images. However, additional methods, such as image analysis and pattern recognition, are employed to index and retrieve images based upon the data itself. Content-based indexing and retrieval methods may utilize one or more methods to compare images based upon image features, color histograms, object shapes, spatial edge distributions, spatial color distributions, texture information, and other features. For purposes of illustration, the following descriptions highlight some of the approaches for content-based indexing and retrieval, but those skilled in the art will recognize other methods, systems, implementations, and uses are within the scope of the present invention.

One method of content-based indexing and retrieval is text-based indexing. Many media collections are annotated with textual information. Photos images or videos images may be tagged or linked with data related to the image. For example, the photo of animals may include information about the names of the animals shown in the photo and/or the location where the image was taken. This textual information may be used for database indexing and searches. In an embodiment, information contained within header fields of images or videos may be used for indexing.

To aid content-based indexing and retrieval, certain formats include additional description tools. For example, the MPEG-7 format includes a variety of information related to the image content, including low-level features information (time, color, textures, audio features, etc.), motion, camera motion, structural information (scene cuts, segmentation in regions, etc.), and conceptual information.

Another method for content-based indexing and retrieval may be referred to as auxiliary information. Auxiliary information refers to additional information related to an image. For example, most modern digital cameras now store many kinds of useful auxiliary information about the images being captured. Examples of such information includes, but is not limited to, date and time information. This information is typically stored in a machine-readable format, which makes it readily available to be used for indexing and retrieval.

Visual content of an image contained within a picture image or video image may be used for indexing. Visual content techniques for indexing include but are not limited to the use of image features such as color histograms, motion vectors, compressed domain features, region shapes, and edge orientation distributions. These features may be used for indexing and retrieval and may also be used to measure the degree of similarity between images.

A related field is that of video-shot segmentation, wherein salient transitions are identified as shot boundaries or scene transitions. For example, when the colors appearing in consecutive video frames are very different, a marker may be placed between the two frames indicating that they belong to two different shots. Examples of video-segmentation techniques are disclosed by Ullas Gargi, Rangachar Kasturi, and Susan H. Strayer in “Performance characterization of video-shot change detection methods,” IEEE Transactions on Circuits and Systems for Video Technology, 10(1):1-13, February 2000, which is incorporated by reference herein in its entirety. Event detection techniques and methods for identifying dramatic events in video streams known to those skilled in the art may also be employed. In an embodiment, the surround visual field may be re-indexed or refreshed when a shot change or event is detected. For example, when a scene change has been detected, the input image may be analyzed to obtain one or more characteristics of the input image. One or more of these characteristics may be used to obtain related images from a database of images, and these returned images used to refresh the surround visual field thereby having the surround visual field relate to the newly changed input image.

A comprehensive survey of the technical literature related to content-based indexing was performed by Arnold W. M. Smeulders, Marcel Worring, Simone Santini, Amarnath Gupta, and Ramesh Jain in “Content-based image retrieval at the end of the early years,” IEEE Transactions on Pattern Analysis and Machine Intelligence, 22(12):1349-1380, December 2000, which is incorporated herein in its entirety by reference. It shall be noted, however, that no particular content-based indexing and retrieval system or technique is critical to the present invention. One skilled in the art will recognize that many different methods may be used to achieve a content-based indexing and retrieval result.

C. Surround Field Controller

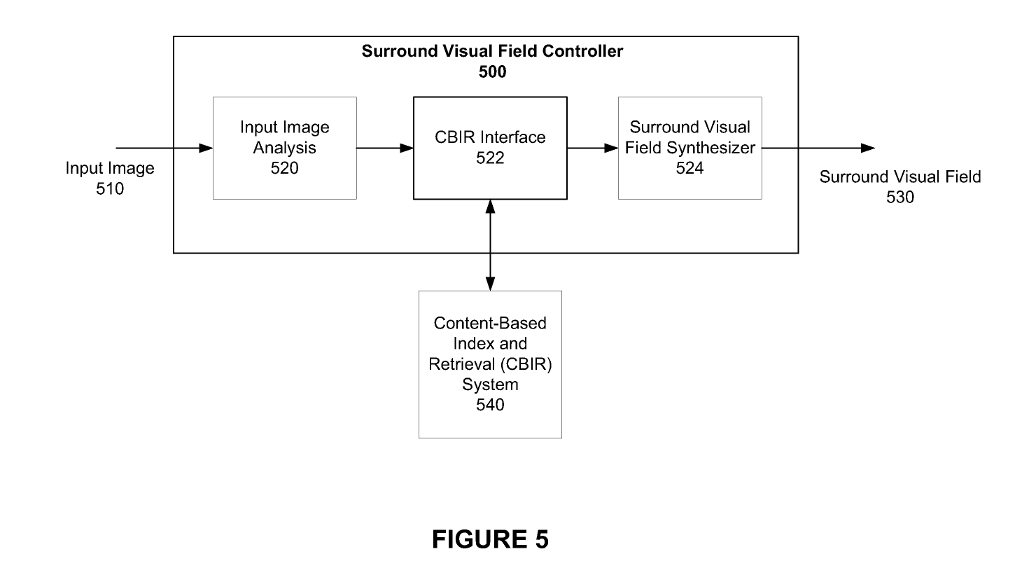

FIG. 5 illustrates an exemplary surround field controller 500 to interface with a content-based indexing and retrieval system or database of images and to synthesize the surround visual field according to one embodiment of the invention. The controller 500 may be integrated within a display device (which shall be construed to mean any type of display device, including without limitation, a CRT display, an LCD display, a projection device, and the like), connected to a display device, or otherwise enabled to control surround visual fields that are displayed in a viewing area. Controller 500 may be implemented in software, hardware, firmware, or a combination thereof. One skilled in the art will also recognize that a number of the elements or module described above may be physical and/or functionally separated into sub-modules or combined together. In an embodiment, the controller 500 receives one or more input signals that may be subsequently processed in order to synthesize at least one surround visual field.

As depicted in FIG. 5, an input image analysis module 520 is coupled to receive an input image 510. It shall be noted that the terms “coupled” or “communicatively coupled,” whether used in connection with modules, devices, or systems, shall be understood to include direct connections, indirect connections through one or more intermediary devices, and wireless connections. The input image analysis module 520 uses one or more analysis techniques as mentioned above to extract or obtain a characteristic or characteristics that may be used to find related images. For example, the input image analysis module 520 may utilize spatial edge information to determine that the input image is a car, metadata that indicates date and time information, and color analysis to determine the car's color. One or more of these characteristics may be supplied to a content-based indexing and retrieval (CBIR) interface 522.

The characteristic or characteristics obtained by the input image analysis module 520 are provided to a content-based indexing and retrieval (CBIR) interface 522, which uses them to obtain one or more related images. In an embodiment, the CBIR interface 522 is communicatively coupled to a CBIR system 540. In one embodiment, the system 540 may be a full CBIR system; alternatively, the CBIR system 540 may be database of images that can be searched.

It should be noted that the word “database” as used herein comprises any collection of two or more images, ranging from arbitrary collections of media to complete database packages. For example, the extra contents included with a movie DVD may be considered a “database,” and so too can a loose collection of digital images, such as images from the Internet. Of course, comprehensive database software packages may also be employed. It should also be understood that the database data may reside on one or more different types of media, including without limitation, flash-based media, disk-drive-based media, server-based media, magnetic media, optical media, and the like.

In an embodiment, the input image and the surround visual field content may be retrieved from one or more databases. In an alternative embodiment, just surround visual field content may be retrieved from one or more databases. One skilled in the art will also recognize that a number of possible indexing and displaying configurations are possible. Possible combinations include, but are not limited to, the following: (i) the first area, or center display portion, may be used to index the database and the surround displays retrieved images; (ii) the surround visual field content may be used to index the database and the center display area may be used to display the retrieved media; and (iii) the center display area and surround visual field may be alternately used to index a database.

As noted previously, no particular CBIR system 540 is critical to the present invention. In an embodiment, the CBIR interface 522 may query the CBIR system 540 using one or more of the input image characteristics, and the CBIR system 540 returns related images. In one embodiment, the returned images may be ranked accordingly to similarity to the query characteristics.

In an embodiment, the input image 510 and the surround visual field contents 530 may or may not be related. One benefit of utilizing a database of images is having access to a large number of high quality images. In an embodiment, the fields may be related indirectly, as illustrated in the following examples. In one example, the input image displays a set of photographs while the surround displays a set of video clips shot at the same location, but possibly at a different time or different times or from different perspectives. In another illustrative example, the center area displays a set of video clips of animals taken at the zoo, while the surround visual field displays a set of photographs of natural wildlife habitats. Alternatively, the input image and the images in the surround visual field may be abstractly related, for example, by displaying random images (i.e., the relationship between the images is that there is no direct relationship).

The returned images are received by the CBIR interface 522, which is also communicatively coupled to a surround visual field synthesizer 524. The surround visual field synthesizer 524 uses the returned images to create or synthesize the surround visual field 530 which is displayed in conjunction with the input image 510. In an embodiment, the surround visual field synthesizer 524 may stretch, mosaic, and/or tile the images into a surround visual field. In an embodiment, controller 500 may include buffering capabilities to allow time for image analysis, querying the database of images, and/or synthesizing the surround visual field.

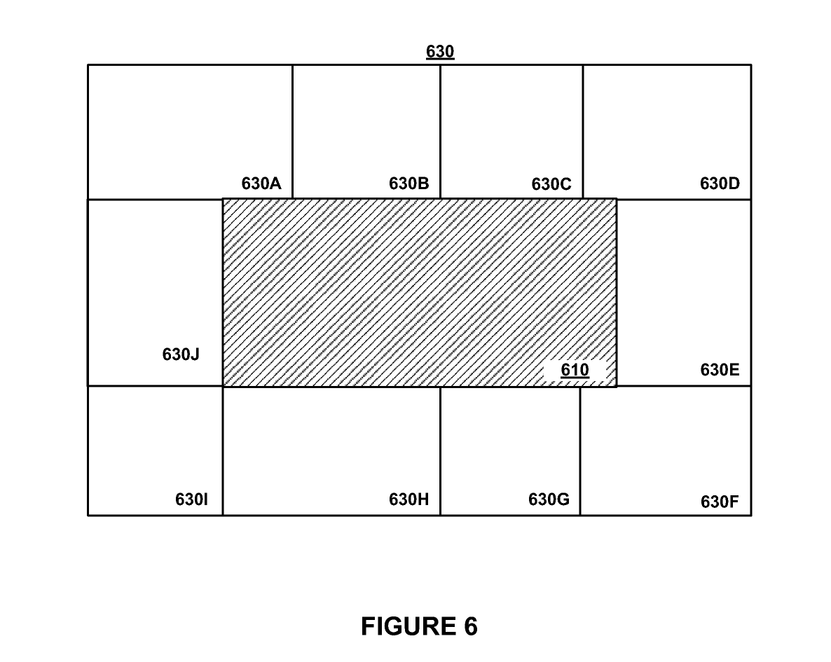

FIG. 6 depicts an embodiment of an input image 610 and a surround visual field display 630. In the depicted embodiment, the input image 610 is displayed in a first, or center, area and is surrounded by images 630A-J, which form the surround visual field 630, which are displayed in second area. The images 630A-J represent images returned from the CBIR database 540 that related, bases upon one or more characteristics, to the input image 610. The images 630A-J may be synthesized into the surround visual field wherein the images take equal or varying areas.

It shall be noted that no particular configuration of controller 500 is critical to the present invention. One skilled in the art will recognize that other configurations and functionality may be excluded from or included within the controller and such configurations are within the scope of the invention.

D. Exemplary Method for Synthesizing a Surround Visual Field

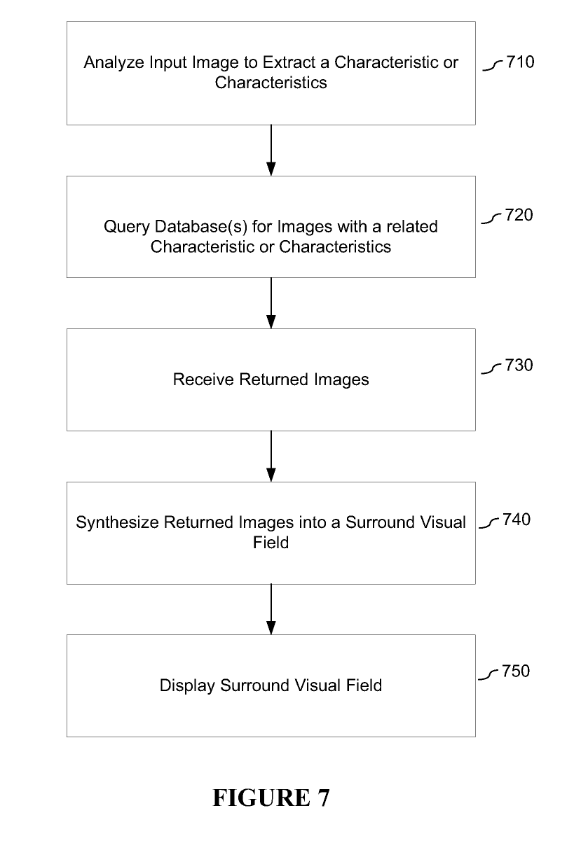

Turning to FIG. 7, an exemplary method for synthesizing a surrounding visual field using a database of images is displayed. In the depicted embodiment, an input image is analyzed to extract or obtain (710) one or more characteristics about the input image. For example, one or more analysis techniques may be employed to extract or obtain a characteristic or characteristics. The extracted characteristics provide a means to obtain related images.

A database of images may be queried (720) using one or more of the extracted characteristics of the input image. In an embodiment, a user may provide input regarding the query, including but not limited to: which characteristics may be used to search, how to rank the characteristics, provide additional characteristics, alter the characteristics, provide exclusionary characteristics, indicate boolean search relationships, set the degree of “similarity” the image should possess, and the like.

One or more images matching or sufficiently matching the query are returned (730) from the database of images, which may be a content-based indexing and retrieval (CBIR) system. In an embodiment, the returned results may be ranked according to the degree of similarity based upon the query characteristics. If a large number of images are returned, a threshold rank level may be set to limit the number of returned images used for the surround visual field. Alternatively, a set number of returned images may be selected. For example, the top ten ranked images may be used for the surround visual field synthesis. The returned images, or a selection thereof, may then be synthesized (740) into a surround visual field. The images may be synthesized into a surround visual field by combining the images to fill or partially fill the second display area. In embodiments, this process may be repeated continuously, at set intervals, at scene changes, or at detected events to re-index or update the surround visual field to the displayed input image.

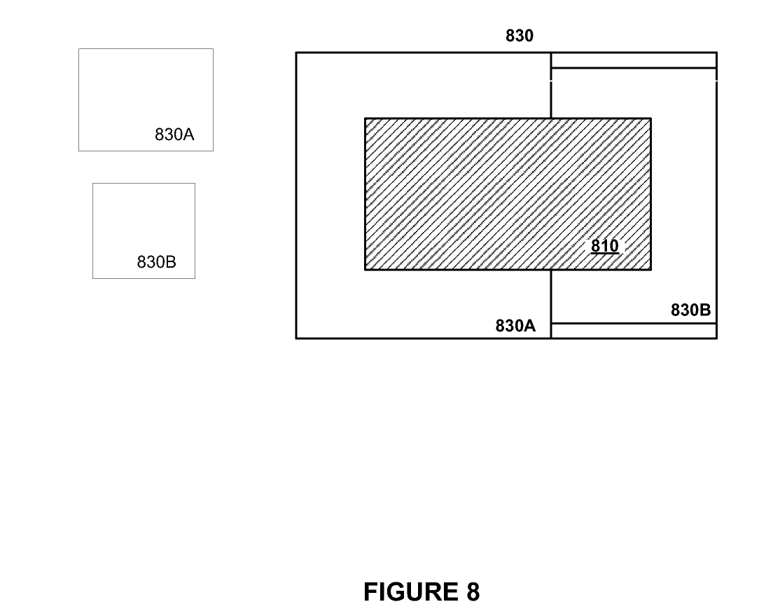

One skilled in the art will recognize that there are a number of methods for synthesizing the surround visual field. In an embodiment, the entire image or images may be presented in the surround visual field. In one embodiment, the image or images may be stretched. FIG. 8 depicts an embodiment of a surround visual field 830, which is comprised of two images 830A and 830B. In the depicted embodiment, images 830A and 830B represent two images obtained from the database of images and have been stretched to fill a greater portion of the surround visual field. In an embodiment, the image may be stretched to fill the entire portion of the surround visual field or an entire dimension (such as the height of the surround visual field), like 830A. Alternatively, as illustrated by image 830B, the image may only be stretched to some portion of the surround visual field.

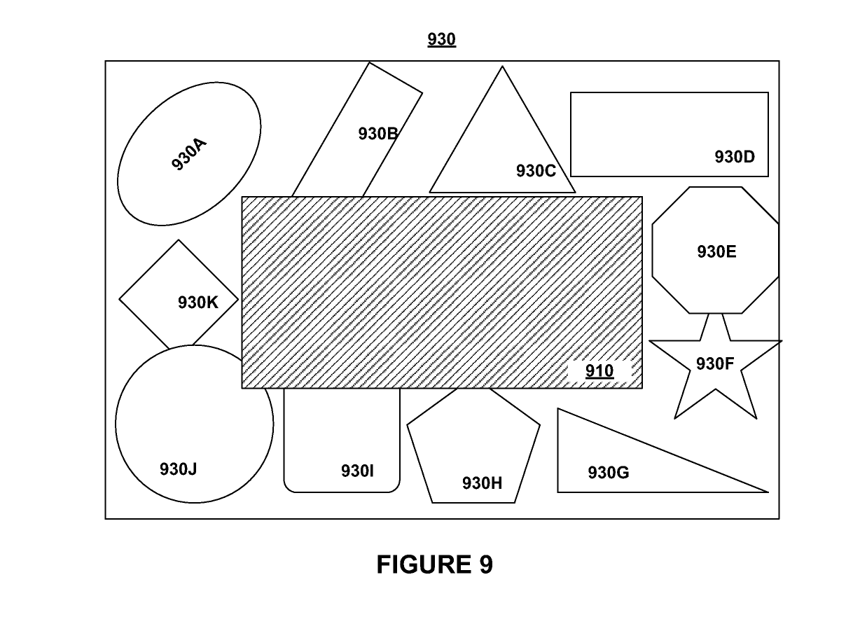

In an embodiment, portions of the image or images may be displayed. One or more image segmentation methods may be applied to decompose the retrieved images. The decomposed portions may be used in the surround visual field. In an embodiment, one or more object detection or recognition methods may be employed to extract specific types of objects from the retrieved image or image. For example, face detection or object detection (such, for example, a car) may be used to extract parts of images. FIG. 9 depicts an embodiment of the surround visual field. In this illustrated example, the images obtained from the database of images 930A-930K may be presented in portions, such as cutout shapes. In an embodiment, the images or the image portions may be randomly placed within the surround visual field. It should also be noted that the images may occlude or obstruct other images, such as 930E covering a portion of image 930F. The images or image portions may be occlude by the input image 910. In an embodiment, the images and/or the input image may have a varying level of transparency/opacity. In an embodiment, the images or image portions may be rotated, such as for example 903B. One skilled in the art will recognize that no method for synthesizing the images from the database of images is critical to the present invention; rather, one skilled in the art will recognize that a number of methods for synthesizing the images into a surround visual field may be employed, which methods fall within the scope of the present invention.

E. Additional Application Examples

For purposes of illustration, listed below are some additional examples of how content-based indexing and retrieval methods may be used to synthesize surround video content. One skilled in the art will recognize additional applications, which are within the scope of the present invention.

1. Video-Driven Slide Show

An example application of the present invention is that of a video-driven slide show. In this application, a collection of digital images exists in a database, and as the input video stream plays, images are retrieved from the database and are displayed in the surround visual field. In an embodiment, the images may be retrieved randomly. In an alternative embodiment, the images in the surround visual field may be related in some measure to the input video stream.

For example, the database may be a collection of images of natural landscapes. As the input video plays, an image or images with features that are most similar to those of the input video frames being displayed may be retrieved and displayed. When the input stream is dominated by bluish hues, an image or images that are similarly dominated by bluish hues may be displayed.

The present invention may also be useful in the simultaneous display of images of an event. For example, during a wedding usually a large collection of images are taken, both photographic and video. A video-driven slide show may be used to display a video while displaying images (photos and/or video) that are related to the input image. One skilled in the art will recognize a number of content-based ways to relate the input image to the surround images, including without limitation, time stamps on the photos/video, color histograms, metadata, or other features.

In an embodiment, compressed-domain features may be used for retrieval of similar images. For example, a feature set may be incorporated into an image-content based management/search method/algorithm for rapid searching of digital images (which may be or may include digital photos or video) for a particular image or group of images. From each digital image to be searched and from a search query image, a feature set containing specific information about that image may be extracted. The feature set of the query image may be compared to the feature sets of the images in a database of image to identify all images that are similar to the query image. In an embodiment, the images may be EXIF formatted thumbnail color images, and the feature set may be a compressed domain feature set based on this format. The feature set may be either histogram- or moment-based. In the histogram-based embodiment, the feature set comprises histograms of several statistics derived from Discrete Cosine Transform (DCT) coefficients of a particular EXIF thumbnail color image, including (i) color features, (ii) edge features, and (iii) texture features, of which there are three: texture-type, texture-scale, and texture-energy, to define that image. Examples of such methods are disclosed in commonly-assigned U.S. patent application Ser. No. 10/762,448, entitled “EXIF-based imaged feature set for content engine,” listing Jau-Yuen Chen as inventor, which is incorporated by reference herein in its entirety.

For example, in an embodiment, a method for managing a database of images that may be selectively searched may involve analyzing the images in the database. For each digital image analyzed, the method comprises partitioning that digital image into a plurality of blocks, each block containing a plurality of transform coefficients, and extracting a feature set derived from transform coefficients of that digital image, the feature set comprising color features, edge features, and texture features including texture-type, texture-scale, and texture-energy.

In an embodiment, the digital color images analyzed may be specifically formatted thumbnail color images.

In an embodiment, the partitioning step comprises partitioning each primary color component of the digital color image being analyzed. The color and edge features may comprise a separate color and edge feature for each primary color of that digital color image. The separate color features may be represented by separate histograms, one for each primary color, and the separate edge features may be likewise represented. The texture-type feature, texture-scale feature, and texture-energy feature may also be represented by respective histograms.

The method may be used to search for images that are similar to a query image, which may be a new image, such as the input image, or an image already in the collection. In the former case, the method may further comprise applying the partitioning and extracting steps to the new digital image to be used as a query image, comparing the feature set of the query image to the feature set of each digital image in at least a subset of the collection, and identifying each digital image in the collection that has a feature set that is similar to the feature set of the query image.

In the case in which an image that has been previously analyzed and had a feature set extracted therefrom is used as the query image, a particular image in the collection may be selected as the query image. Then, the feature set of the selected query image may be compared to the feature set of each digital image in at least a subset of the collection, and each image in the collection that has a feature set that is similar to the feature set of the selected query image may be identified.

In embodiments, an image or images may be periodically retrieved from a database or databases that matches the current video frame, and display it in the surround visual field.

2. Indexing DVD Extra Content

The present invention may be utilized in other applications, such as with existing multimedia items, such as movies. Many movie or videos, which are currently stored in DVD format, provide a great deal of extra content that is related to the feature item. The DVD format is capable of storing semantic content, such as textual subtitles (often in multiple languages), cast/crew biography/filmography, and even in-movie links to extra contents like extended versions of scenes or trivia information. All of this included extra content may be considered as a “database” that is made for and related to the feature item. Relevant content from this database of extra content may be searched and displayed in a surround visual field, such as, for example, while the feature presentation is displayed in the central display area.

3. Enhancing Other Kinds of Surround Video Animation

Content-based indexing and retrieval techniques for shot boundary detection and scene transition detection may also be used to enhance surround visual field displays. For example, if a shot boundary is detected, an animation, such as a starfield animation, may be made to react immediately to the change in video content. This makes the animation more responsive, and less likely to miss sharp changes in the scene motion. Animation within the surround visual field is discussed in U.S. patent application Ser. No. 11/294,023, filed on Dec. 5, 2005, entitled “IMMERSIVE SURROUND VISUAL FIELDS,” listing inventors Kar-Han Tan and Anoop K. Bhattacharjya, which is incorporated herein by reference in its entirety.

Those skilled in the art will recognize that various types and styles of surround fields may be depicted and are within the scope of the present invention. One skilled in the art will recognize that no particular surround field configuration, nor content-based index and retrieval system or method is critical to the present invention. It should also be understood that an element of a surround field shall be construed to mean the surround field, or any portion thereof, including without limitation, a pixel, a collection of pixels, and a depicted image or object, or a group of depicted images or objects.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application-specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

We claim:

1. A system for displaying a surround field of related images comprising:
a database of images that is selectively searchable based upon at least one characteristic;
a surround visual field controller that obtains a characteristic of an input image, receives at least one image from the database of images that relates to the characteristic of the input image, and generates a surround visual field comprising the at least one image; and
a display device, communicatively coupled to the surround visual field controller, that displays the input image in a first area and displays the surround visual field in a second area that at least partially surrounds the first area.

2. The system of claim 1 wherein the surround visual field controller obtains a characteristic of the input image by analyzing the input image.

3. The system of claim 2 wherein the characteristic of the input image is related to the content of the input image.

4. The system of claim 1 wherein the database of images comprises video images and still images.

5. The system of claim 4 wherein the database is a content-based indexing and retrieval database, which is selectively searchable based upon a content-based characteristic.

6. The system of claim 5 wherein the content-based characteristic is at least one selected from the group comprising: text-based information, auxiliary information, visual feature information, color information, motion vectors, compressed domain features, region shapes, edge orientation distributions, metadata information, time information, date information, content motion, and camera motion.

7. The system of claim 1 wherein the display device comprises a first display device that displays the input image in the first area and a second display device that displays the surround visual field in the second area.

8. A method of generating a surround visual field comprising at least one image that relates to an input image, the method comprising:
analyzing the input image to obtain a characteristic of the input image; and
selectively searching a database of images to obtain at least one image that relates to the characteristic of the input image;
synthesizing the at least one image into a surround visual field; and
displaying the input image in a first area and displaying the surround visual field in a second area that at least partially surrounds the first area.

9. The method of claim 8 wherein the step of analyzing the input image to obtain a characteristic of the input image comprises the step of:
using a content-based analysis technique to obtain a content-based characteristic as the characteristic.

10. The method of claim 9 wherein the content-based characteristic is at least one selected from the group comprising: text-based information, auxiliary information, visual feature information, color information, motion vectors, compressed domain features, region shapes, edge orientation distributions, metadata information, time information, date information, content motion, and camera motion.

11. The method of claim 10 wherein the database of images is a content-based indexing and retrieval database.

12. The method of claim 8 wherein the at least one image that relates to the characteristic of the input image are ranked.

13. The method of claim 8 wherein the steps are repeated to update the surround visual field.

14. A computer-readable medium carrying one or more sequences of instructions which, when executed by one or more processors, cause the one or more processors to perform at least the steps of the method of claim 8.

15. A surround visual field controller comprising:
an input image analysis module, communicatively coupled to receive an input image, that analyzes the input image to obtain at least one characteristic of the input image;
a database interface, communicatively coupled to receive the at least one characteristic of the input image, that uses the characteristic to obtain from a database of images at least one image that relates to the input image characteristic; and
a surround visual field generator, communicatively coupled to receive the at least one image that relates to the input image characteristic, that synthesizes a surround visual field comprising the at least one image that relates to the input image characteristic, wherein the surround visual field is to be displayed in an area that at least partially surrounds a display of the input image.

16. The controller of claim 15 wherein the database of images comprises video images and still images.

17. The controller of claim 16 wherein the database of images is a content-based indexing and retrieval database, which is selectively searchable based upon a content-based characteristic.

18. The controller of claim 15 wherein the input image analysis module obtains the characteristic of the input image by using a content analysis technique to obtain a content-based characteristic.

19. The controller of claim 15 wherein the surround visual field generator synthesizes the surround visual field by modifying the at least one image that relates to the input image characteristic.

20. The controller of claim 19 wherein the at least one image that relates to the input image characteristic is modified by at least one of the group comprising: stretching, rotating, tiling with another image, selecting a portion of the at least one image, and applying a degree of transparency to the at least one image.
